(19) United States
(12) Patent Application Publication
(10) Pub. No.: US 2005/0004273 A1
(43) Pub. Date: Jan. 6, 2005

(54) Asphalt composition comprising linear diblock copolymer

(76) Inventors: Moon-Seok Chun, Daejeon-city (KR); Jae-Cheol Cho, Daejeon-city (KR); Kyu-Seok Sim, Daejeon-city (KR); Choon-Hwa Lee, Seoul (KR)

Correspondence Address: CANTOR COLBURN, LLP, 55 GRIFFIN ROAD SOUTH, BLOOMFIELD, CT, 06002, US

(21) Appl. No.: 10/497,405

(22) PCT Filed: Dec. 4, 2002
(86) PCT No.: PCT/KR02/02277

(30) Foreign Application Priority Data
Dec. 4, 2001 (KR) 2001-0076370

(51) Int. Cl. C08L 95/00

(52) U.S. Cl. 524/59

(57) ABSTRACT

The present invention relates to an asphalt composition comprising a linear diblock copolymer. Particularly, an asphalt composition comprising a linear diblock copolymer consisting of a vinyl aromatic hydrocarbon/conjugated diene has superior dispersion, elongation and a high softening point, and an asphalt composition to which a small amount of sulfur compound is further added has more improved dispersion and thus elongation and softening temperature can be improved more effectively.

### BACKGROUND OF THE INVENTION

(a) Field of the Invention

The present invention relates to an asphalt composition comprising a linear diblock copolymer, and more particularly to an asphalt composition comprising a linear diblock copolymer consisting of a vinyl aromatic hydrocarbon/conjugated diene having remarkably improved dispersion.

(b) Description of the Related Art

Asphalt-paved roads have a very narrow range of operational temperature because asphalt, which functions to bind aggregate in pavement, has problems of cracking at low temperatures and permanent deformation at high temperatures. It is becoming more serious as the volume of traffic grows bigger.

For these reasons, the efforts to improve and to modify asphalt have been made and studies on asphalt modifiers were executed to maintain the shape stability of an asphalt/aggregate mixture at high and low temperatures.

The current asphalt modifiers are predominantly high molecular weight polymers such as olefin/acryl monomer copolymers, vinyl aromatic hydrocarbon/conjugated diene random copolymers, and vinyl aromatic hydrocarbon/conjugated diene block copolymers, etc. whose compatibility with asphalt are known. The most effective compound is a vinyl aromatic hydrocarbon/conjugated diene block copolymer, and it has been confirmed that the copolymer remarkably broadens the operation temperatures of asphalt. However, since the added amount of vinyl aromatic hydrocarbon/conjugated diene block copolymer applied to asphalt is very small dispersion of the compound is extremely important. Therefore there is a strong requirement to improve the dispersion of hydrocarbon/conjugated diene block copolymer in asphalt composition.

### SUMMARY OF THE INVENTION

It is an object of the present invention to provide an asphalt composition comprising a vinyl aromatic hydrocarbon/conjugated diene block copolymer having superior dispersion, which has improved low temperature elongation and an improved softening temperature.

In order to achieve these objects, the present invention provides an asphalt composition comprising:
a) asphalt; and
b) a linear diblock copolymer of a vinyl aromatic hydrocarbon/conjugated diene.

The present invention also provides an asphalt composition further comprising a sulfur compound.

### DETAILED DESCRIPTION AND THE PREFERRED EMBODIMENTS

The present invention will be explained in detail.

The T_{ODT} (Order-Disorder Transition Temperature) of a linear diblock copolymer consisting of a vinyl aromatic hydrocarbon and a conjugated diene is lower than those of a linear triblock or star-shaped copolymer consisting of a vinyl aromatic hydrocarbon block, a conjugated diene block, and a vinyl aromatic hydrocarbon block. Accordingly, the present inventors confirmed that a linear diblock copolymer, when added to asphalt, has superior dispersion to those of a linear triblock copolymer or a radial block copolymer at the same molecular weight.

The present invention provides an asphalt composition comprising a linear diblock copolymer consisting of a vinyl aromatic hydrocarbon and a conjugated diene, and also provides an asphalt composition further comprising a coupling agent, eg. sulfur compound.

Preferably, the linear diblock copolymer consisting of a vinyl aromatic hydrocarbon and a conjugated diene has an average molecular weight of 5,000 to 500,000, and a ratio of vinyl aromatic hydrocarbon to conjugated diene of 5:95 to 40:60. In addition, the linear diblock copolymer may further comprise a vinyl aromatic hydrocarbon/conjugated diene copolymer block.

The linear diblock copolymer used in the present invention is prepared by adding a vinyl aromatic hydrocarbon and a conjugated diene to a reactor containing a hydrocarbon solvent and an organolithium. compound, polymerizing at −50 to 150° C. under 0 to 10 bar so as to maintain the reactant in a liquid state until the monomer conversion becomes 99%, and adding water or alcohol to terminate polymerization.

As the hydrocarbon solvent, n-pentane, n-hexane, n-heptane, isooctane, cyclohexane, toluene, benzene, xylene, various aromatic hydrocarbons or naphthalene hydrocarbons, etc. can be used, and preferably n-hexane, cyclohexane, or a mixture thereof is used.

In addition, a small amount of polar solvent can be added to the hydrocarbon solvent, and the polar solvent functions to control the vinyl content in conjugated diene polymerization and improve the polymerization rate. The polar solvents include tetrahydrofuran, ethylether, or tetramethylethylenediamine, etc., and tetrahydrofuran is particularly preferable.

As the organolithium compound, an alkyl lithium compound can be used, and a C3-10 alkyl lithium compound is particularly preferable. Examples include methyl lithium, ethyl lithium, isopropyl lithium, n-butyl lithium, sec-butyl lithium, and tert-butyl lithium, and n-butyl lithium or sec-butyl lithium is preferable.

As the vinyl aromatic hydrocarbon, one or more kinds of styrene, a -methylstyrene, 3-methylstyrene, 4-methylstyrene, 4-propylstyrene, 1-vinyinaphthalene, 4-cyclohexylstyrene, 4-(p-methylphenyl)styrene, or 1-vinyl-5-hexylnaphthalene, etc. can be used, and styrene is preferable.

As the conjugated diene, one or more kinds of 1,3-butadiene, 2,3-dimethyl-1,3-butadiene, piperilene, 3-butyl-1,3-octadiene, isoprene, or 2-phenyl-1,3-butadiene, etc. can be used, and 1,3-butadiene is preferable.

The linear diblock copolymer and asphalt are mixed by the following method.

500 g of asphalt are introduced in a mixing vessel, temperature and agitation speed are maintained at 150° C. and 400 rpm, respectively, and then a predetermined amount of a linear diblock copolymer is added. The agitation speed is slowly raised to 4,000 rpm, the temperature is elevated to 170° C., and the mixture is agitated for 1 hour. When a sulfur compound is added, the mixture is further agitated for 1 hour after the addition to proceed reaction.

The weight ratio of the linear diblock copolymer and asphalt is preferably 0.1:99.9 to 20:80, and more preferably 1:99 to 10:90.

The sulfur compound that can be further added is preferably a fine powder having a maximum particle size of 100 mesh, and the molecular structure of the sulfur is not important. The amount of sulfur compound added largely affects physical properties of the asphalt/block copolymer, so preferably the amount of sulfur compound added is 0.001 to 0.2 pha (part/hundred asphalt).

The asphalt composition of the present invention uses a linear diblock copolymer consisting of a vinyl aromatic hydrocarbon and a conjugated diene having superior dispersion, and thus it has superior low temperature elongation and an improved softening point, and the low temperature elongation and softening temperature can be more easily improved by adding a small amount of sulfur compound to the composition.

The present invention will be explained in more detail with reference to the following Examples, but these are only to illustrate the present invention and the present invention is not limited to them.

### EXAMPLE 1

Preparation of Linear Diblock Copolymer

A styrene-butadiene linear diblock copolymer with a styrene weight content of 15% was prepared as follows.

To a nitrogen-substituted 20 L reactor, 9,600 g of purified cyclohexane, 225 g of styrene, and 1,275 g of butadiene were introduced and agitated. To the above mixture, 0.4 g of n-butyllithium was added when the temperature of the liquid mixture became 50° C., to polymerize the styrene and butadiene.

After all monomers were consumed, 0.2 g of water was added to the reactor. Then, 7.5 g of the antioxidant Irganox1076 (Ciba Specialty Chemicals Co.) and 15.0 g of TNPP (Weston Chemical Co.) were added to the polymer solution to prepare a linear diblock copolymer with a molecular weight of 200,000 g/mol and a styrene block content of 15 wt %.

### COMPARATIVE EXAMPLE 1

Preparation of Triblock Copolymer

A linear triblock copolymer with a styrene weight content of 31% was prepared as follows.

To a nitrogen-substituted 20 L reactor, 8,620 g of purified cyclohexane and 465 g of styrene were introduced and agitated. 1.5 g of n-butyllithium was added when the temperature of the liquid mixture became 60° C. to polymerize the styrene, and 1,035 g of butandiene were added and the reaction continued until the butadiene was completely consumed. Then, 1.725 g of dimethylsilane dichloride was introduced into the reactor to cause a coupling reaction, and 0.2 g of water was added to carry out termination of unreacted active copolymer. Then, 7.5 g of the antioxidant Irganox1076 (Ciba Specialty Chemicals Co.) and 15.0 g of TNPP (Weston Chemical Co.) were added to the polymer solution to prepare a triblock copolymer with a molecular weight of 120,000 g/mol and a styrene block content of 31 wt %.

### EXAMPLES 2 TO 6 AND COMPARATIVE EXAMPLES 2 TO 5

Preparation of Asphalt Composition

### EXAMPLE 2

20.83 g of the linear diblock copolymer prepared in Example 1 and 500 g of AP-5 asphalt with physical properties as shown in Table 1 were introduced in a mixing vessel, and they were agitated for 1 hour to prepare an asphalt composition.

Physical properties of asphalt were measured as follows:

Penetration—Measured according to ASTM 5, after standing at 25° C. for 3hours.

Softening temperature—Measured according to ASTM 36.

Low temperature elongation—Measured according to ASTM 113, after standing at 5° C. for 3 hours.

Viscosity—Measured according to ASTM 4402 with Brookfield DV2+Model.

TABLE 1

| | Pene- | | | | | |
|---|---|---|---|---|---|---|
| | tration | Softening | | | | |
| | (dmm, | Point | Elongation | Viscosity (cps) | | |
| Asphalt | 5 sec) | (° C.) | (cm, 5° C.) | 80° C. | 100° C. | 120° C. |
| AP-5 | 64˜68 | 54.1˜55.1 | 5> | 22,300 | 4,060 | 1,070 |

### EXAMPLES 3˜6

0.050 pha (part/hundred asphalt), 0.075 pha, 0.100 pha, and 0.120 pha (0.25 g, 0.375 g, 0.5 g, and 0.6 g as a weight amount) of a sulfur compound (Sulfur Element, 1 grade reagent, purity 98% or more) were added respectively to asphalt compositions of Example 2 and agitated for 1 hour to prepare 4 asphalt compositions.

### COMPARATIVE EXAMPLE 2

20.83 g of the triblock copolymer prepared in Comparative Example 1 and 500 g of AP-5 asphalt with the physical properties as shown in Table 1 were introduced in a reaction vessel and agitated for 1 hour to prepare an asphalt composition.

### COMPARATIVE EXAMPLES 3˜5

0.120 pha, 0.200 pha and 0.250 pha (0.6 g, 1,0 g and 1.25 g as weight amount) of sulfur compound were respectively added to asphalt compositions of Comparative Example 2 by the same method as in Examples 3 to 6, and agitated for 1 hour to prepare 4 asphalt compositions.

Physical properties of the asphalt compositions prepared in Examples 2 to 6 and Comparative Examples 2 to 5 were measured by the same method as in Example 2, and the results are shown in Table 2.

TABLE 2

| | | Penetration | | | | | |
|---|---|---|---|---|---|---|---|
| Asphalt | Sulfur added | (dmm, 5 | Softening | Elongation | Viscosity (cps) | | |
| Composition | amount (pha) | sec) | point (° C.) | (cm, 5° C.) | 100° C. | 120° C. | 135 |
| Example 2 | 0 | 57 | 63.9 | 5.0> | 19,700 | 4,900 | 2,170 |
| Example 3 | 0.050 | 45 | 70.6 | 31.5 | 29,900 | 6,320 | 2,540 |
| Example 4 | 0.075 | 44 | 69.7 | 48.8 | 30,900 | 6,720 | 2,590 |
| Example 5 | 0.100 | 46 | 76.0 | 60.0 | 37,700 | 8,400 | 3,120 |
| Example 6 | 0.120 | 52 | 87.1 | 58.8 | 284,000 | 56,000 | 20,000 |
| Comparative | 0 | 45 | 72.5 | 35.5 | 18,200 | 3,840 | 1,520 |
| Example 2 | | | | | | | |
| Comparative | 0.120 | 51 | 74.0 | 42.0 | 28,000 | 5,300 | 2,110 |
| Example 3 | | | | | | | |
| Comparative | 0.200 | 49 | 78.4 | 40.3 | 38,400 | 6,390 | 2,550 |
| Example 4 | | | | | | | |
| Comparative | 0.250 | 48 | 78.0 | 37.0 | 49,000 | 8,080 | 2,800 |
| Example 5 | | | | | | | |

As shown in Table 2, the asphalt compositions of Examples 2 to 6 of the present invention comprising a linear diblock copolymer have superior physical properties to those of Comparative Example 2 to 5 comprising the existing triblock copolymer. In addition, the asphalt compositions of Examples 3 to 6 where a sulfur compound was added to asphalt compositions have remarkably improved physical properties and elongation compared to the asphalt composition of Example 2 without the sulfur compound.

According to the present invention, an asphalt composition with superior elongation and an improved softening temperature can be provided by including a linear diblock copolymer consisting of a vinyl aromatic hydrocarbon and a conjugated diene with excellent dispersion, and elongation and softening temperature can be more easily improved by further adding a small amount of a sulfur compound.

1. An asphalt composition comprising;
a) asphalt; and
b) a linear diblock copolymer of a vinyl aromatic hydrocarbon/conjugated diene.

2. The asphalt composition according to claim 1, wherein the composition further comprises a sulfur compound.

3. The asphalt composition according to claim 1, wherein a weight ratio of the vinyl aromatic hydrocarbon and the conjugated diene is 5:95˜40:60, and an average molecular weight is 5,000-500,000.

4. The asphalt composition according to claim 1, wherein the vinyl aromatic hydrocarbon is selected from a group consisting of styrene, α-methylstyrene, 3-methylstyrene, 4-methylstyrene, 4-propylstyrnee, 1-vinylnaphathalene, 4-cyclohexylstyrene, 4-(ρ-methylphenyl)styrene, 1-vinyl-5-hexylnaphthalene, and a mixture thereof.

5. The asphalt composition according to claim 1, wherein the conjugated diene is selected from a group consisting of 1,3-butadiene, 2,3-dimethyl-1-3-butadiene, piperilene, 3-butyl-1,3-octadiene, isoprene, 2-phenyl-1,3-butadiene, and a mixture thereof.

6. The asphalt composition according to claim 1, wherein the vinyl aromatic hydrocarbon is styrene and the conjugated diene is butadiene.

7. The asphalt composition according to claim 1, wherein a weight mixing ratio of the linear diblock copolymer and asphalt is 0.1:99.9˜20:80.

8. The asphalt composition according to claim 2, wherein the sulfur compound is added in an amount of 0.001˜0.2 pha (part/hundred asphalt).
